(19) United States
(12) Patent Application Publication
(10) Pub. No.: US 2003/0144960 A1
(43) Pub. Date: Jul. 31, 2003

(54) Method for online commercial distribution of digital goods through a comminication network and eletronic device for purchasing electronic goods distributed by said method

(76) Inventor: Radoslaw Galka, Draveil (FR)

Correspondence Address: YOUNG & THOMPSON, 745 SOUTH 23RD STREET 2ND FLOOR, ARLINGTON, VA, 22202

(21) Appl. No.: 10/312,335

(22) PCT Filed: Jun. 26, 2001
(86) PCT No.: PCT/FR01/02013

(30) Foreign Application Priority Data
Jun. 26, 2000 (FR) 00/08138

(51) Int. Cl. G06F 17/60

(52) U.S. Cl. 705/52

(57) ABSTRACT

The invention concerns a method for distributing digital goods via a communication network (R), comprising steps which consist in: (a) connecting with a terminal (T), electronic payment means (P); (b) following an order instruction made by said client to the purchase terminal to order a digital good of his choice, sending said credit data (7) to a supplier server, (d) sending, from the server to the purchase terminal said digital good (26) comprising a file of digital data executable or not The invention is characterised in that said digital good comprises a separate file of rights to use (225) defining terms and conditions of use of the digital good selected by the client, said method comprising steps which consist in: (f) storing in said storage (1) of the electronic payment means said data concerning rights to use (25).

The present invention relates to a method of commercial distribution of digital products by way of a communication network; as well as an electronic device for purchasing digital products by way of a communication network and a ready-to-install on-line purchasing system. More precisely, the digital products to which the invention relates are executable digital data set(s) intended to be used and destined to be supplied in a usable form according to predefined terms of use.

Open networks for communicating or transporting data, such as the Internet, exhibit very wide potentialities in respect of commerce. Electronic commerce, an expression which designates on-line commercial transactions by way of the Internet, is set for very strong growth on account of the growth in the number of users of the Internet, and of the numerous advantages which it exhibits: ability to purchase and to sell at any point of the globe, speed which favors the reduction of stocks. Particularly, electronic commerce appears very advantageous for commerce in products which can be transported in digitized form, audio and/or video recording, film disks, software, texts, images, etc. since it considerably reduces the distribution costs as compared with conventional routes. However, the security of the exchanges on an open network such as this, that is to say on which the exchanges between two speakers can be read by a third party, is more complex to ensure.

Currently, the most widespread authentication and payment process for securing on-line transactions on the Internet relies on SSL protocol (the initials standing for Secure Socket Layer). SSL is an information communication protocol which makes it possible to ensure the authentication of the speakers, the confidentiality of the communications, and the integrity of the data exchanged on the Internet. This protocol uses a recognized means of cryptography: the RSA public key algorithm. An RSA key is a pair formed of a public key and a private key, which is the result of operating between prime numbers. Any message encoded with the public key of a pair can be read only with the private key of said pair.

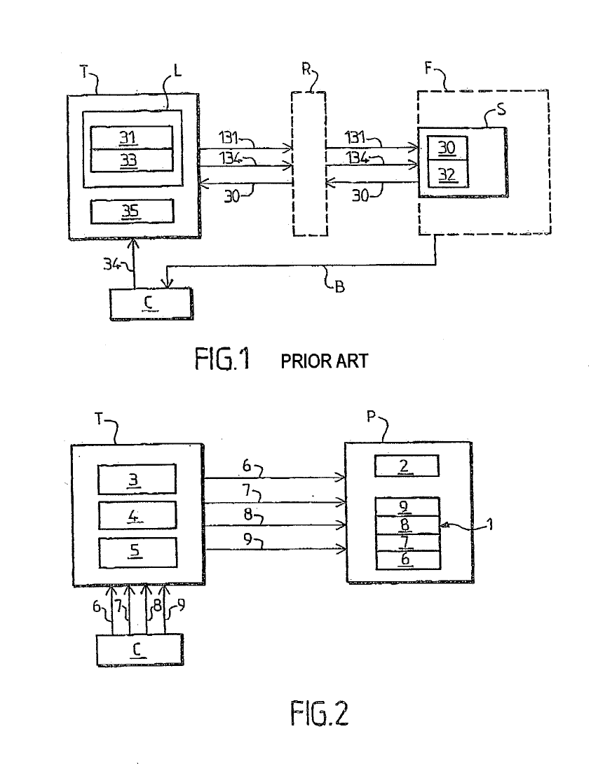

With reference to FIG. 1, the placing of a purchase order with the aid of the SSL protocol by a customer C, having a terminal T able to communicate with a server S of a supplier F by way of an open network R, will now be described. Before the sensitive information is exchanged, the SSL protocol performs the management of the RSA keys and the authentication of the server. To authenticate the server S of an electronic commerce site on the Web, the purchase software L, executed on the computer terminal T by the customer C, asks the server S to supply it with its public key 30. The terminal T receives the public key 30 from the server S then encodes the public key 31 generated by the software L with the public key 30 of the server S, and returns the outcome of this operation, the encoded key 131, to the server S. Only the server S possesses the private key 32 corresponding to the public key 30. Thus, the server S decodes the key 131 to obtain the public key 31 of the software L. The server S encodes its messages for the purchase software L with the public key 31, so that only the software L can decode these messages with the aid of the private key 33, corresponding to the public key 31. A third party who has observed the exchange cannot decode the key 131, and therefore cannot pass itself off as the server S at the software L. By repeating this procedure, this time commencing with the server S, the server S can authenticate the software L of the customer C. Thus, the two speakers can communicate confidentially.

When the customer C wishes to place a purchase order for a product B, the software L invites him to enter payment parameters 34 on a keyboard 35. The payment parameters generally comprise the name, the address of the customer C, the number of a payment card, its type (for example VISA®, American Express®) and its date of expiry. The software L encrypts these data and transmits the encrypted payment parameters 134 to the server S. The supplier F then carries out the verification of the payment parameters 34 and confirms the order through a message to the customer C, said message being able to comprise an invoice. The product B can then be delivered by postal package for example.

Another process for authenticating persons involved in an on-line purchase is the SET protocol (the initials standing for Secure Electronic Transaction®). This system uses cryptography protocols and delivers certificates of authenticity of the electronic transactions.

Both the SSL and SET processes have drawbacks, including their unwieldiness and their rigidity. In the SSL protocol, the payment parameters have to be entered with each transaction, with the risks entailed by such entry, if it is done in a public place. The SET solution is unwieldy to implement on account of the certificates of authenticity which have to be exchanged with each transaction.

The document EP 917 119 A2 sets forth an electronic wallet distributed net-like system comprising an information bank in which a user stores various types of personal information and a chip card containing secret connectors for authorizing ubiquitous roaming access of the user to this information, while guaranteeing its confidentiality. In this system, the user's credit data are stored permanently in the information bank so as to allow invoicing internal to the information bank. Thus, the user can make purchases on Internet trader sites by way of the information bank without passing on information such as a bank card number via the Internet. This system also makes provision for an access ticket, for example, an admission to the opera, to be stored on the chip card. However, this system comprises drawbacks in that it makes the user entirely dependent on the information bank, which centralizes all his personal data and always serves as intermediary for the transactions performed by the user with third parties. Thus, this system deprives the user of desirable control over his own affairs. Furthermore, the centralization of the personal data is a risk factor for the user. Finally, the information bank has to be remunerated for its services as intermediary.

The on-line commercial distribution of digital products by way of a communication network is a particular form of on-line commercial transaction. The purchase of digital products on-line by way of a communication network is a particular form of on-line commercial ordering. The document WO 99/49615 A1 sets forth a method of on-line commercial distribution of digital products by way of a communication network, said method comprising the steps consisting in:

(a) placing an electronic means of payment, intended to be carried by a customer, in communication in a removable manner with a first computer terminal, the so-called purchase terminal, credit data identifying a credit of said customer being stored in a memory of said electronic means of payment,

(b) subsequent to an order command given by said customer to the purchase terminal so as to order a digital product of his choice, sending said credit data from the purchase terminal to a second computer terminal, the so-called server, of a supplier, said credit data being encrypted, said server and said purchase terminal being able to communicate by way of said communication network,

(c) verifying the validity of said credit data and, when said credit data are valid,

(d) sending, from the server to the purchase terminal, said digital product comprising at least one executable or non-executable digital data file.

According to this known method, the data file, for example a digitized document is stored in an encrypted manner on a storage cartridge for which, on the one hand, the purchase terminal, and on the other hand, the personal computer of the customer, must be furnished with a specific reader. For purposes of protection against pirating, a single reader or a restricted set of readers, whose serial numbers have been input into the cartridge, allows the use of the digital product stored therein. The means of payment is a conventional bank card, with magnetic stripe or the like, and the customer must furthermore possess a personal identification card separate from the bank card so as to be able to use the purchase terminal. This method and this system therefore exhibit a degree of unwieldiness of use. The need to possess at one and the same time a payment card, an identification card and a storage cartridge so as to make a purchase renders the latter irksome and increases the risks that a desired purchase cannot be carried out as a result of forgetting one of these three elements. Moreover, the product purchased is devoid of flexibility of use since use is not made from the purchase terminal and the reader adapted to the cartridge must be carried with the cartridge to any place of use.

The aim of the present invention is to propose a method of commercial distribution of digital products by a network while resolving at least some of the aforesaid drawbacks. The method according to the invention affords five major advantages to customers: the automation and securing of the process of payment by the use of a chip card and of an appropriate reader; the opening up to any valid payment card; the personalization of the range of products marketed on-line and the personalization of the advertising messages by virtue of dynamic management of the customer's preferences stored in the chip card; the direct conveying of digital products such as software, audio and/or video recordings purchased, by downloading, on the customer's terminal, or encrypted or unencrypted electronic files containing these goods in a form which can be used only by way of the chip card.

To do this, the invention provides a method of the above type characterized in that said digital product comprises a separate file of rights of use data defining the digital product's terms of use chosen by the customer and one or more other data file(s), said rights of use data being sent encrypted according to an encryption code for which a secret decryption key is stored in the memory of said electronic means of payment, said method comprising the steps consisting in:

(e) storing said other data file or files on the purchase terminal,

(f) storing in said memory of the electronic means of payment said rights of use data by decrypting them with the aid of said decryption key, said rights of use data being indispensable to the use of said digital product.

For example, the electronic means of payment is a chip card able to execute cryptographic algorithms and the purchase terminal is a microcomputer equipped with a chip card reader. Such a chip card is furnished with a memory, for example with a capacity of 32 kilobytes or more. The server is, for example the server of a site or of an electronic commerce portal on the Web.

This method thus makes it possible to carry out purchases directly from suppliers without involving any intermediary institution. It offers security against pirating insofar as the means of payment which served to carry out the purchase must be linked to the interface to allow the use of the product acquired. However, it also offers flexibility of use since the other file(s) can be transferred or copied, for example via the communication network, onto another terminal furnished with an interface adapted to the means of payment. It does not need any particular precautions against pirating during such a transfer since only the means of payment connected to an interface allows the product to be used from a terminal. It should be noted that a computer terminal furnished with a chip card reader is a relatively common object.

Advantageously, said order command produces the sending by the purchase terminal, to the server, of data of orders designating said digital product chosen by the customer and the terms of use chosen by the customer, according to which said digital product is intended to be used, the rights of use data being intended to authorize use of said digital product according to said chosen terms of use.

In a preferred embodiment said other file(s) comprises/comprise an executable computer program, said use comprising an execution of said computer program, said computer program being designed in such a way that its execution comprises operations which are not subject to authorization consisting in reading the rights of use data in said electronic means of payment and in authorizing or otherwise, as a function of said rights of use data, the execution of at least one following operation which is subject to authorization.

In another preferred embodiment, said other file(s) comprises/comprise at least one non-executable document file, said use comprising operations which are not subject to authorization consisting in reading the rights of use data in said electronic means of payment and in authorizing or otherwise, as a function of said rights of use data, the execution of at least one operation of processing said document file(s) by a corresponding processing means.

In a combination of these preferred embodiments, said computer program executable by said purchase terminal constitutes said processing means, said following operation(s) comprising said operation(s) of processing said document file(s).

Preferably, the method according to the invention comprises a step consisting in:

(g) at least partially encrypting said other data file(s) according to said encryption code before storing it (them) on the purchase terminal, said method comprising a step of decryption of the encrypted part of said other data file(s) by said electronic means of payment when a use of the digital product is commanded. The encrypted part can also be empty.

The storage of at least one part of the digital product in an encrypted form on the purchase terminal and of the corresponding decryption key on a removable means of payment offers an additional guarantee against the pirating of the digital product.

Advantageously, the method according to the invention comprises, before step (a), a step consisting in supplying the customer with the electronic means of payment together with included encryption and decryption keys and for which keys the supplier possesses corresponding respective decryption and encryption keys.

Advantageously, the method according to the invention also comprises a step of mutual authentication which comprises, on the one hand, the sending by said electronic means of payment, to said second computer terminal, by way of said first computer terminal and of said communication network, of a random number, on the other hand, the returning by said second computer terminal, to said electronic means of payment, by way of said communication network and of said first computer terminal, of said random number received, after encryption with the aid of an authentication key of said second computer terminal, a necessary condition for the recognition of authenticity of said second computer terminal by said electronic means of payment being the receipt of said random number encrypted by said electronic means of payment and the matching of said random number sent and said random number encrypted, after decryption of the latter by said electronic means of payment.

Preferably, the terms of use defined by said rights of use data comprise chronological terms such as a maximum duration of use or a limit date of use and/or quantitative terms such as a maximum number of uses and/or qualitative terms such as a restriction of use to a subset of said digital product.

The invention also provides an electronic device for purchasing digital products on-line by way of a communication network, said device comprising:

an electronic means of payment intended to be carried by a customer and furnished with a memory, credit data identifying a credit of said customer being stored in said memory,

a purchase computer terminal linked to a computer server of said supplier by said communication network, and furnished with a control interface for receiving an order command given by the customer so as to order a digital product of his choice,

an electronic interface linked to said purchase terminal, said electronic interface being able to receive in a removable manner said electronic means of payment so as to allow an exchange of data between said purchase terminal and said electronic means of payment,

software drive means for driving the operations consisting in:

(a) sending said credit data from said electronic means of payment to said server, said credit data being encrypted,

(b) when said credit data have been validated, receiving from the server said digital product comprising at least one executable or non-executable data file, characterized in that said digital product comprises a separate file of rights of use data defining the digital product's terms of use chosen by the customer and one or more other data file (s) , said rights of use data being received encrypted, said software drive means being able to drive the operations consisting in:

(c) storing said other data file(s) on the purchase terminal,

(d) storing said rights of use data in said memory of the electronic means of payment by having them decrypted by the electronic means of payment with the aid of a secret decryption key stored in the memory, said rights of use data being indispensable to the use of said digital product.

For example, the electronic means of payment is a chip card able to execute the cryptographic algorithms and the electronic payment interface is a chip card reader in which said chip card can be inserted.

Preferably, said control interface allows the customer to command a use of said digital product.

Preferably, said other data file(s) is/are received at least partially encrypted according to said encryption code, said software drive means being able to drive an operation consisting in having the encrypted part of said other data file(s) decrypted by the electronic means of payment with the aid of said secret decryption key when said use is commanded.

The invention also provides a ready-to-install on-line purchase system comprising said electronic means of payment, said electronic interface and said software drive means for the electronic device mentioned above, said electronic means of payment being or not being linked to said electronic interface, said electronic interface being or not being linked to said purchase terminal and said software means being fixed on a data medium.

The invention will be better understood and other aims, details, characteristics and advantages thereof will become more clearly apparent in the course of the following description of several particular embodiments of the invention, given merely by way of non-limiting illustration, with reference to the appended drawing.

In this drawing:

FIG. 1 is a diagrammatic representation of a procedure for making a purchase by way of a communication network according to a prior art;

FIG. 2 is a diagrammatic representation of a step of initializing a chip card forming part of a method according to the invention;

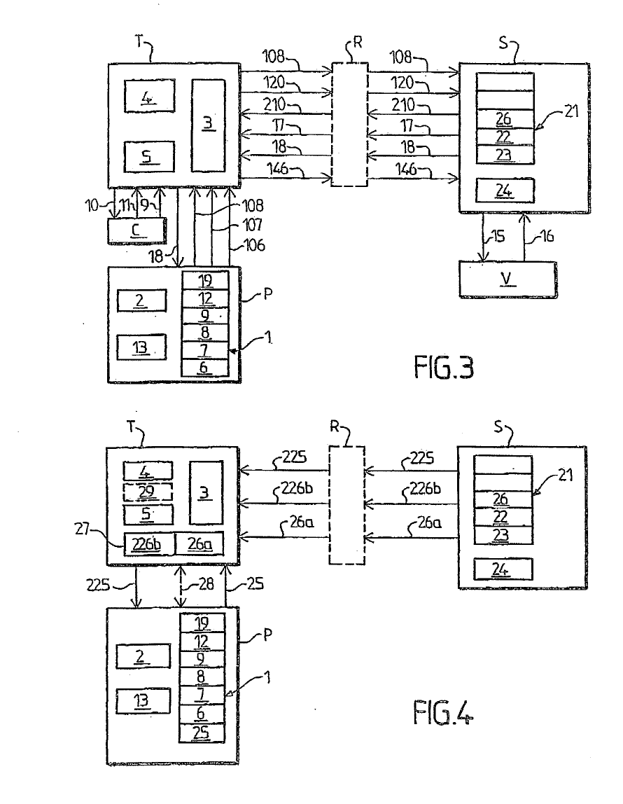

FIG. 3 is a diagrammatic representation of a first purchasing step of the method of FIG. 2;

FIG. 4 is a diagrammatic representation of a second purchasing step of the method of FIG. 2;

FIG. 5 is a chart representing the progression of a use of the digital product acquired by the method of FIGS. 2 to 4 in a first embodiment;

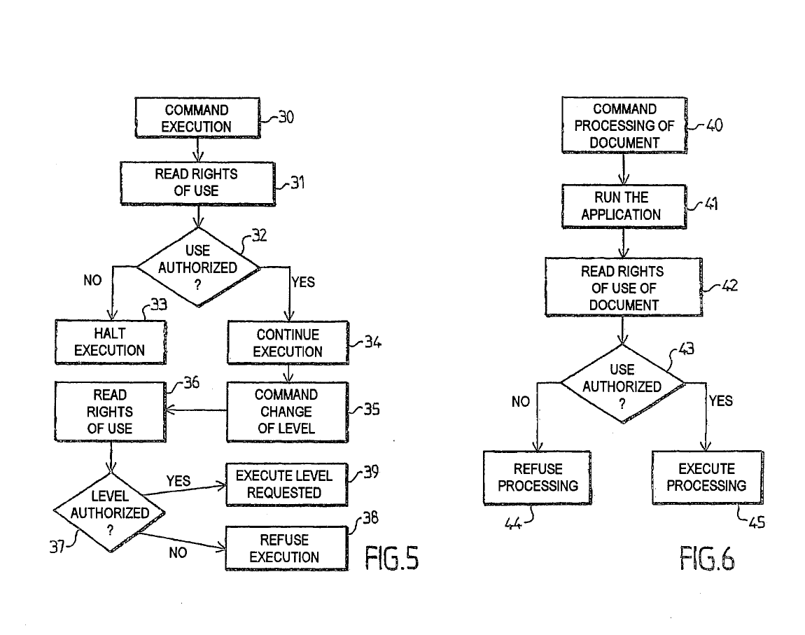

FIG. 6 is a chart representing the progression of a use of the digital product in a second embodiment.

An electronic device according to an embodiment of the invention will now be described with reference to FIG. 2. The electronic device in this embodiment of the invention comprises a chip card P, which comprises for example a rigid plastic reinforcement (not represented) in which is mounted an integrated circuit in a memory unit 1, a microprocessor 2, and electrical contacts (not represented) able to come into contact with a chip card reader so as to allow the exchanging of data between the chip card P and said reader. The device according to the invention also comprises a chip card reader 3, linked to a computer terminal T for exchanging data with the latter. As represented in FIG. 2, the chip card reader 3 can be integrated into the terminal T. As a variant, the chip card reader 3 can be a peripheral external to the terminal T. The device according to the invention also comprises software means 4, which comprise instruction codes able to be executed by the terminal T and/or the chip card reader 3 so as to drive the progression of a method of purchase. The software means 4 are installed on the terminal T and/or the chip card reader 3 by any appropriate means, either by way of a physical data medium of CD ROM type (not represented), or by downloading.

The chip card P, the reader 3 and the software means 4 can be supplied in the form of a system ready to install on a conventional personal computer, such as a microcomputer of PC-compatible type. The software means 4 are then supplied fixed on a physical data medium. The reader 3 is supplied with a cord for linking it to said personal computer. The method driven by the software drive means 4 will now be described.

In a first step of the method, a customer C initializes his chip card P so as to render it usable in order to perform on-line transactions. To do this, the chip card P is inserted into the chip card reader 3. An initialization application, supplied in the software means 4, is executed. The customer C is then invited to enter various items of information relating to himself by way of a control interface 5, for example, an alphanumeric keyboard and/or a mouse, of the terminal T. These various items of information comprise, for example: personal data 6 identifying the customer C (for example his name, his address, his date of birth), bank data or the like 7, identifying a credit of the customer C (for example, a bank card number of the customer C, the type of said bank card and its date of expiration), personal preferences data 8 characteristics, of the consumer preferences of the customer C (address of a preferred electronic commerce site, name of preferred commercial brands and/or of distributors, etc.). After the entry of this information, the customer C is invited to supply a personal identification code 9; next the reader 3 transmits the personal data 6, the bank data 7, the personal preferences data 8 and the personal identification code 9 to the chip card P, so that this information is stored in the memory unit 1. The initialization step is then terminated.

Preferably, the customer C must keep his personal identification code 9 secret, so as to reserve access to the information stored on his chip card. The personal identification code 9 is necessary in order to view and/or modify said information stored with the aid of the initialization application. The personal identification code 9 is of course completely independent of other personal codes belonging to the customer C, such as for example the confidential code associated with his bank card.

During the initialization step, which must be performed at least before the very first purchase with the aid of the chip card P, it is not necessary for the terminal T to be connected to any network. Moreover, the entering of the sensitive data, such as the bank data 7, can be performed at an appropriate place, and not at the place where the purchase is made, which may be in a public place, such as an Internet cafe, for example.

After this initialization step, the electronic device allows the customer C to make on-line purchases from a supplier F, by way of a communication network R, as represented in FIGS. 3 and 4. To do this, the terminal T must be linked to the network R, so as to communicate with a computer server S of the supplier F, likewise linked to the network R. The server S is, for example, the server of an electronic commerce site on the Web. In what follows, the communications between the server S and the terminal T always pass through the network R. The network R is an open network of the Internet type, that is to say that a third party could intercept the data exchanged between the server S and the terminal T.

To make a purchase, the customer C inserts his chip card P into the reader 3. The terminal T is then able to enter automatically into communication with the server S of the electronic commerce site whose address features in the preference data 8 stored in the chip card P. As a variant, the customer C can choose a different server S by entering his address via the control interface 5.

When the terminal T has begun communicating with the server S, the two computer speakers S and T identify themselves mutually during an authentication step, performed according to a standard authentication procedure established for cryptographic chip cards, and which is transparent to the customer C, such as for example, the abovementioned RSA public key algorithm.

For the authentication procedure (not represented), the server S possesses a pair of authentication keys, the one public 36, the other private 37. The server S reveals its public authentication key 36 to the terminal T without passing via the network R. The terminal T generates a random number 38 and sends it to the server S by way of the network R. The server S encrypts this random number 38 received with the aid of its private authentication key 37 and returns the result 39 of this encryption operation to the terminal T. The terminal T uses the public authentication key 36 revealed previously to decrypt the result 39 received and compares said decrypted result 40 with the random number 38 sent. If they correspond, the terminal T is certain of corresponding with the server S. An imposter would not have been able to ascertain the private authentication key 37 of the server S and would be incapable of correctly encrypting the random number 38.

On completion of the authentication step, the terminal T is able to send the server S data encrypted according to a first encryption code, which the server S is able to decrypt, to the exclusion of any third party who might observe the exchanges on the network R between the terminal T and the server S; and the server S is able to send the terminal T data encrypted according to a second encryption code which only the terminal T furnished with the chip card P is able to decrypt, to the exclusion of any third party. In FIGS. 3 and 4, the data encrypted according to the first encryption code have a numeral increased by 100 and the data encrypted according to the second encryption code have a reference numeral increased by 200. The chip card comprises a reference numeral increased by 200.

The chip card P comprises in the memory unit 1 a so-called second decryption key 12 necessary for the decryption of said second encryption code, as well as a first encryption key 19 necessary for the encryption according to the first encryption code. Thus, the terminal T can neither decrypt said second encryption code, nor encrypt data according to said first encryption code, when the chip card P is withdrawn from the reader 3. The operations of encryption according to a first code of the data sent by the terminal T to the server S and of decryption of the data sent to the terminal T by the server S and encrypted according to the second encryption code are performed by a cryptographic module 13 in the chip card P. The server S comprises a second cryptographic module 24 for encrypting according to the second code with the aid of a second encryption key 23 and for decrypting the first code with the aid of a first decryption key 22, said second encryption key 23 and said first decryption key 22 being stored in a memory 21 of the server S.

The encryption key 19 corresponding to the first code and the decryption key 12 corresponding to the second code are fixed in the chip card P without passing through the network R. For example, the supplier F is himself the issuer of the chip card so that he supplies it to the customer C with the integrated keys 19 and 12. For example, in the case where the RSA public key algorithm is used for the mutual authentication of the speakers, the second encryption key 23 is a public key generated by the chip card P and the second decryption key 12 is the private key associated therewith; while the first encryption key 19 is a public key generated by the server S and the first decryption key 22 is the private key associated therewith.

After the authentication step, the terminal T sends the server S the preference data 8 encrypted according to the first encryption code. After receipt of the encrypted preference data 108, the server S sends the terminal T response data 10, encrypted or otherwise, intended to inform and/or influence the customer C. The response data 10 comprise for example information regarding goods in accordance with the preference data 8, advertisements and/or commercial offers personalized according to the preference data 8.

The supplier F can also organize a lottery in which his customers, who use the method according to the invention to carry out transactions with him, participate. For example, the server S is able to randomly draw the name of a winner from the customers connected to the server S at a given time and to dispatch a gift offer to the winning customer.

Preferably, the server S is able to store the history of the transactions performed by a given customer with the aid of the method according to the invention, for example, the amount and the nature of the past transactions, and to adapt the offers contained in the response data 10 as a function of the customer's loyalty. In a variant of the invention, the preference data 8 stored in the chip card P are updated automatically as a function of the transactions performed by the customer C, with the aid of said chip card P. The history of the past transactions of the customer C can be stored in said memory unit 1 and be included in the preference data 8 communicated to the server S.

The following step of the method is an ordering step. When the customer C has chosen a product to order from the supplier F, he sends the terminal T an order command 11 with the aid of the control interface 5. For example, the order command 11 is sent by simple actuation of a mouse button. The terminal T then requests the entry of the personal identification code 9 to verify that the chip card P is legitimate. When the code entered on the control interface 5 agrees with the personal identification code 9 stored in the memory unit 1, the terminal T automatically sends the server S order data 146 and payment data 120 encrypted according to the first encryption code, the payment data 120 comprising all or some of the personal data 6 and of the bank data 7, so as to make the payment for the product.

The order data 146 designate a digital product 26 to be supplied by the supplier F and available by way of the server S, that is to say in the embodiment represented, stored on the server S. The digital product 26 consists of a set of usable, executable or non-executable, digital data. With the digital product 26, the customer C chooses terms of use according to which he will be able to use the product ordered. For example, the price of the digital product ordered depends on the terms of use ordered therewith. The order data 146 therefore; also designate the terms of use according to which said digital product is intended to be used.

On receipt of the order data 146 and of the encrypted payment data 120, the server S proceeds to their decryption with the aid of the first decryption key 22. Preferably, the server S is able to communicate automatically with a verification computer server V, for example a computer server of a banking organization, so as to verify the validity of the bank data 7 and/or the creditworthiness of the customer C. In response to the verification request 15 sent by the server S, the verification server V sends a confirmation of validity 16, positive or negative depending on whether the bank data 7 are deemed valid or otherwise. When the confirmation of validity 16 received is negative, the server S sends the terminal T a cancellation order 17 to cancel the transaction in progress. Under these particular conditions, to prevent an attempted illegitimate purchase, in the case, for example, where no credit identified by the bank data 7 exists, the server S also sends a disabling order 18 to disable the chip card P. When the confirmation of validity 16 received is positive, the order is accepted by the server S. A credit account of the customer is debited in this case.

The end of the ordering step will now be described with reference to FIG. 4. The server S sends the terminal T data identifying the product ordered, encrypted according to the second encryption code. Under the control of the software drive means 4, the terminal T redirects the encrypted identifying data to the chip card P. The identifying data are decrypted by the decryption module 13 of the chip card P and stored in the memory unit 1. The identifying data uniquely identify the product ordered and paid for by the customer C, so as to stand as proof of the order placed. Terms of use of the product, such as, for example a maximum duration of use or a maximum number of uses are included in the identifying data. Within the meaning of the invention, the terms of use include rights of use data 25.

The rights of use data 25 are intended to be read from the electronic means of payment so as to cooperate with the digital product when a use of the product is commanded. They are intended to cooperate with the digital product 26 so as to authorize its use solely according to the terms of use ordered by the customer C, and as a function of which the digital product is, invoiced.

The digital product 26 comprises the rights of use data 25, in the form of a separate data file, and at least one other computer file. The digital product 26 can be an executable computer program such as video games software, educational software or some other commercial application. Such a program comprises for example an executable file for booting the software and the libraries of functions, static or dynamic, which are called or otherwise by the executable file of the software as a function of the functionalities used by the user. This computer program is designed in such a way that execution thereof is impossible in the absence of the rights of use data 25.

The terms of use ordered by the customer C together with the computer program may be chronological terms, such as a limit date of execution or a total duration of execution, limited or otherwise; quantitative terms, such as a total number of executions, limited or otherwise; or qualitative terms such as a set of accessible and usable functionalities which is restricted or otherwise as compared with the complete functionalities of the computer program. For example, in video games software or educational software comprising several successive levels, the customer C can order the use of certain levels alone. In this case, the libraries of functions corresponding to the levels whose use has not been ordered and paid for are supplied by the server S in a locked form or are not supplied.

The digital product 26 can also comprise a non-executable document file which can be used by processing by means of an appropriate processing means 29. For example, it may be a sound document file, such as a disk digitized in the MP3 format, an audiovisual document file such as a film digitized in the MPEG4, AVI, WAV or MOV format, a graphics document file such as an image in the JPEG, GIF format, or another document file comprising a content in a format readable by appropriate reading software. This document file is designed in such a way that processing thereof is impossible in the absence of the rights of use data 25.

The terms of use ordered by the customer C together with the document file may be chronological terms, such as a limit date of reading or a total duration of reading, limited or otherwise; quantitative terms, such as a total number of reads, limited or otherwise; or qualitative terms such as a restriction of reading to a sub-part of the complete document file.

As identification of the digital product 26, the data 25 comprise, for example the name and the serial number of the software or of the document, its date of creation and the list of files which form part thereof.

In all cases, the server S also sends the terminal T each file of the digital product 26. The digital product 26 is sent in the form of the encrypted rights of use data 225, and of the other computer file(s) composed of a part 226b encrypted according to the second encryption code and of a non-encrypted part 26a. The non-encrypted part 26a or the encrypted part 226b may be empty. Preferably the encrypted part 226b of the file or files is also indispensable to the use of the digital product 26. For example, in the case where the product is a computer program, a part of the executable code or one of the main libraries is contained in the part 226b. For example, in the case where the product is an audiovisual document file, a slice of half a second of the document every second is contained in the part 226b.

On their receipt by the terminal T, the encrypted part 226b and the non-encrypted part 26a of the other computer file(s) are stored in a memory 27 of the terminal T. For it to be possible for the product to be used from the terminal T after downloading, for example, to listen to the purchased disc or to execute said purchased software, the encrypted part 226b of the files must be decrypted by the cryptographic module 13 and then forwarded to the terminal T by the chip card P, as represented by the double arrow 28 in FIG. 4. As will now be explained with reference to FIGS. 5 and 6, the rights of use data 25 (or identifying data) are intended to be read from the chip card P during each use of the downloaded digital product 26. Thus, for it to be possible for the file(s) of the product 26 to be used, the chip card P which served in placing the order must be connected to the reader 3.

The progression of a use of the digital product 26 downloaded will now be described, with reference to FIG. 5, in the case involving software having several levels. In step 30, a user gives, through the control, interface 5, a command to execute the software. The execution of the software commences with step 31, which is not subject to authorization, in which the rights of use data 25 are read from the memory 1, as indicated by the arrow 25 in FIG. 4. If the chip card P is not connected to the reader 3, step 31 is not performed but a message is addressed to the user, for example: “please insert the card into the reader”.

In step 32, the software performs a verification of the rights of use to establish whether the execution of the software is authorized. For example, the limit date of execution is compared with the current date given by the internal clock of the terminal T or the value of an executions counter is compared with the value of the maximum number of authorized executions which is contained in the rights of use 25. If it is established that use is not authorized, for example the limit date of execution having passed or the maximum number of executions having been reached during the previous execution, execution is interrupted at step 33.

If execution is authorized, it continues in step 34. The part 226b of the software is then completely decrypted by the module 13 and thereafter stored decrypted in the memory 27, in such a way as to be able to be executed or called. In the course of the execution of the software, the user reaches the end of a level and requests access to the higher level at step 35. Then, in step 36 the rights of use data 25 are again read from the memory 1 to establish, in step 37, whether access to the higher level is authorized, for example by comparing the number of said higher level with a list of accessible levels which is contained in the data 25. If it is established that access to the higher level is not authorized, execution at this level is refused in step 38 and a message “level not accessible” is displayed on the screen. If access is authorized, the higher level is executed in step 39.

As a variant, the encrypted part 226b is only partially decrypted in step 34, functions which are not necessary for the execution of the current level remaining encrypted so as to be decrypted later, when they are necessary for the continuation of execution. For example, the functions necessary for execution of the higher level are decrypted upon switching to the higher level when this switching is authorized.

The progression of a use of the digital product 26 downloaded will now be described, with reference to FIG. 6, in the case involving a document file, for example a digitized musical sequence. In step 40, a user gives, through the control interface 5, a command to read the musical sequence, for example by clicking on a corresponding icon. In step 41, the implementation of a means of processing 29, visible in FIG. 4, is instigated namely, in the present example, the execution of software for reading 29, which is able to read the digitizing format employed in the digital product 26. The execution of the reading software commences with step 42, which is not subject to authorization, in which the rights of use data 25 are read from the memory 1, as indicated by the arrow 25 in FIG. 4. If the chip card P is not connected to the reader 3, step 31 is not performed but a message is addressed to the user, for example: “please insert the card into the reader”.

In step 43, the software performs a verification of the rights of use to establish whether the reading of the document file is authorized. For example, the limit date of reading is compared with the current date given by the internal clock of the terminal T or the value of a read counter is compared with the value of the maximum number of authorized reads which is contained in the rights of use 25. If it is established that reading is not authorized, execution of the reading software is interrupted in step 44.

If reading is authorized, it is continued in step 45. The part 226b of the document file is then decrypted by the module 13, either entirely before starting the reading proper, or in real time as and when the encrypted parts are reached in the course of the reading of the document.

The processing by the means of processing 29 of the document file produces the effects expected by the user, namely, in the present example, the issuing of the musical sequence by a sound reproduction appliance, not represented, linked to the terminal T. The means of processing 29 can be installed on the terminal T before acquisition of the digital product 26. As a variant, in the case of executable software, the means of processing 29 can be supplied from the server S under the aforesaid conditions. For example, the digital product 26 comprises a document file and corresponding reading software, each or one of them having its terms of use predefined by the data 25.

When a user wishes to widen or renew his rights of use of a previously acquired digital product, for example, to access a level of the software to which he had not acquired access, or to acquire the rights to additional reads of the document file after exhausting the maximum number of authorized reads which he had acquired initially, he can, with the aid of the device according to the invention, order rights of use alone, so as to renew the rights of use data 25 stored on his chip card. He need not again download the other computer files already stored on the purchase terminal in order to use them again.

Although the invention has been described in conjunction with several particular variant embodiments, it is obvious that it is in no way limited thereto and that it comprises all the technical equivalents of the means described as well as their combinations, if the latter come within the framework of the invention.

1. A method of on-line commercial distribution of digital products by way of a communication network (R), said method comprising the steps consisting in:
(a) placing an electronic means of payment (P), intended to be carried by a customer (C), in communication in a removable manner with a first computer terminal (T), the so-called purchase terminal, credit data (7) identifying a credit of said customer being stored in a memory (1) of said electronic means of payment,
(b) subsequent to an order command (11) given by said customer to the purchase terminal so as to order a digital product of his choice, sending said credit data. (7) from the purchase terminal (T) to a second computer terminal (S), the so-called server, of a supplier (F), said credit data being encrypted, said server and said purchase terminal being able to communicate by way of said communication network (R),
(c) verifying the validity of said credit data and, when said credit data are valid,
(d) sending, from the server to the purchase terminal, said digital product (26) comprising at least one executable or non-executable digital data file, characterized in that said digital product comprises a separate file of rights of use data (225) defining the digital product's terms of use chosen by the customer and one or more other data file(s), said rights of use data being sent encrypted according to an encryption code for which a secret decryption key (12) is stored in the memory (1) of said electronic means of payment (P), said method comprising the steps consisting in:
(e) storing said other data file or files (26a, 226b) on the purchase terminal,
(f) storing in said memory (1) of the electronic means of payment (P) said rights of use data (25) by decrypting them with the aid of said decryption key (12), said rights of use data being indispensable to the use of said digital product.

2. The method as claimed in claim 1, characterized in that said order command (11) produces the sending by the purchase terminal, to the server, of data of orders (146) designating said digital product chosen by the customer and the terms of use chosen by the customer, according to which said digital product is intended to be used, the rights of use data being intended to authorize use of said digital product according to said chosen terms of use.

3. The method as claimed in claim 1 or 2, characterized in that said other file(s) comprises/comprise an executable computer program, said use comprising an execution of said computer program, said computer program being designed in such a way that its execution comprises operations (31) which are not subject to authorization consisting in reading the rights of use data (25) in said electronic means of payment (P) and in authorizing or otherwise (32), as a function of said rights of use data, the execution of at least one following operation (34) which is subject to authorization.

4. The method as claimed in claim 1 or 2, characterized in that said other file(s) comprises/comprise at least one non-executable document file, said use comprising operations which are not subject to authorization consisting in reading (42) the rights of use data (25) in said electronic means of payment (P) and in authorizing or otherwise (3), as a function of said rights of use data, the execution of at least one operation (45) of processing said document file(s) by a corresponding processing means (29).

5. The method as claimed in claims 3 and 4, taken in combination, characterized in that said computer program executable by said purchase terminal constitutes said processing means (29), said following operation(s) comprising said operation(s) (45) of processing said document file(s).

6. The method as claimed in any one of claims 1 to 5, characterized in that it comprises a step consisting in:
(i) at least partially encrypting said other data file(s) according to said encryption code before storing it (them) on the purchase terminal, said method comprising a step of decryption (28) of the encrypted part (226b) of said other data file(s) by said electronic means of payment (P) when a use of the digital product is commanded (30, 40).

7. The method as claimed in one of claims 1 to 6, characterized in that it comprises, before step (a), a step consisting in supplying the customer with the electronic means of payment together with included encryption (19) and decryption (12) keys and for which keys the supplier possesses corresponding respective decryption (22) and encryption (23) keys.

8. The method as claimed in one of claims 1 to 7, characterized in that the terms of use defined by said rights of use data (25) comprise chronological terms such as a maximum duration of use or a limit date of use and/or quantitative terms such as a maximum number of uses and/or qualitative terms such as a restriction of use to a subset of said digital product.

9. An electronic device for purchasing digital products on-line by way of a communication network (R), said device comprising:
an electronic means of payment (P) intended to be carried by a customer (C) and furnished with a memory (1), credit data (7) identifying a credit of said customer (C) being stored in said memory (1),
a purchase computer terminal (T) linked to a computer server (S) of said supplier (F) by said communication network (R), and furnished with a control interface (5) for receiving an order command (11) given by the customer so as to order a digital product of his choice,
an electronic interface (3) linked to said purchase terminal (T), said electronic interface being able to receive in a removable manner said electronic means of payment (P) so as to allow an exchange of data between said purchase terminal (T) and said electronic means of payment (P),
software drive means (4) for driving the operations consisting in: (a) sending said credit data (7) from said electronic means of payment to said server (S) , said credit data being encrypted, (b) when said credit data have been validated, receiving from the server said digital product (26) comprising at least one executable or non-executable data file, characterized in that said digital product comprises a separate file of rights of use data (225) defining the digital product's terms of use chosen by the customer and one or more other data file(s), said rights of use data being received encrypted, said software drive means (4) being able to drive the operations consisting in: (c) storing said other data file(s) (26a, 226b) on the purchase terminal, (d) storing said rights of use data (225, 25) in said memory (1) of the electronic means of payment (P) by having them decrypted by the electronic means of payment with the aid of a secret decryption key (12) stored in the memory (1), said rights of use data being indispensable to the use of said digital product.

10. The electronic device as claimed in claim 9, characterized in that said control interface (5) allows the customer to command (30, 40) a use of said digital product.

11. The electronic device as claimed in claim 10, characterized in that said other data file(s) is/are received at least partially encrypted according to said encryption code, said software drive means (4) being able to drive an operation (28) consisting in having the encrypted part (226b) of said other data file(s) decrypted by the electronic means of payment with the aid of said secret decryption key (12) when said use is commanded.

12. A ready-to-install on-line purchase system comprising said electronic means of payment (P), said electronic interface (3) and said software drive means (4) for the electronic device according to one of claims 9 to 11, said electronic means of payment being or not being linked to said electronic interface, said electronic interface being or not being linked to said purchase terminal and said software means being fixed on a data medium.
